(19) United States
(12) Patent Application Publication
(10) Pub. No.: US 2025/0192311 A1
(43) Pub. Date: Jun. 12, 2025

(54) BATTERY PACK ATTACHMENT ASSEMBLY THAT SECURES A BATTERY PACK TO A VEHICLE FRAME

(71) Applicant: Ford Global Technologies, LLC, Dearborn, MI (US)

(72) Inventor: John Peter Bilezikjian, Canton, MI (US)

(21) Appl. No.: 18/952,270

(22) Filed: Nov. 19, 2024

Related U.S. Application Data
(60) Provisional application No. 63/607,888, filed on Dec. 8, 2023.

(51) Int. Cl. H01M 50/249; B60K 1/04; H01M 50/264

(52) U.S. Cl. CPC H01M 50/249; B60K 1/04; H01M 50/264; B60K 2001/0438

(57) ABSTRACT

A battery pack attachment assembly includes a battery pack bracket of an attachment assembly that secures a battery pack to a frame member of a vehicle. The battery pack bracket is removably secured to a battery pack. The battery pack bracket includes a flange that is received within a pocket when the battery pack is secured to the frame member with the attachment assembly.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to a battery pack attachment assembly and, more particularly, to an assembly that secures a battery pack to a vehicle frame in a way that facilitates later servicing of the battery pack.

### BACKGROUND

Electrified vehicles differ from conventional motor vehicles because electrified vehicles can be selectively driven by one or more electric machines that are powered by a battery pack. The electric machines can propel the electrified vehicles instead of, or in combination with, an internal combustion engine. From time to time, servicing the battery pack can be necessary.

### SUMMARY

In some aspects, the techniques described herein relate to a battery pack attachment assembly, including: a battery pack bracket of an attachment assembly that secures a battery pack to a frame member of a vehicle, the battery pack bracket removably secured to a battery pack, the battery pack bracket including a flange that is received within a pocket when the battery pack is secured to the frame member with the attachment assembly.

In some aspects, the techniques described herein relate to a battery pack attachment assembly, further including a vehicle frame bracket that provides the pocket, the vehicle frame bracket attached to a vehicle frame.

In some aspects, the techniques described herein relate to a battery pack attachment assembly, wherein the vehicle frame bracket includes one or more fastener bores each configured to receive a fastener to secure the battery pack bracket to the vehicle frame bracket.

In some aspects, the techniques described herein relate to a battery pack attachment assembly, wherein the one or more fastener bores each open vertically upward.

In some aspects, the techniques described herein relate to a battery pack attachment assembly, wherein the pocket opens vertically upward.

In some aspects, the techniques described herein relate to a battery pack attachment assembly, wherein the pocket opens upward, and the pocket is configured to receive the flange from above.

In some aspects, the techniques described herein relate to a battery pack attachment assembly, wherein the flange includes a hooked portion that is at least partially received within the pocket.

In some aspects, the techniques described herein relate to a battery pack attachment assembly, wherein the battery pack bracket is removably secured to an enclosure flange of the battery pack.

In some aspects, the techniques described herein relate to a battery pack attachment assembly, wherein the battery pack bracket interfaces directly with an upper surface of the enclosure flange.

In some aspects, the techniques described herein relate to a battery pack attachment assembly, further including at least one mechanical fastener extending vertically upward through the enclosure flange to engage the battery pack bracket to removably secure the battery pack bracket to the enclosure flange.

In some aspects, the techniques described herein relate to a battery pack attachment assembly, wherein the at least one mechanical fastener is configured to be disengaged from the battery pack bracket from a position vertically beneath the enclosure flange.

In some aspects, the techniques described herein relate to a battery pack attachment assembly, wherein the battery pack bracket is configured to be detached from the battery pack when the flange is received within the pocket.

In some aspects, the techniques described herein relate to a battery pack attachment assembly, wherein a vehicle frame member includes the pocket.

In some aspects, the techniques described herein relate to a battery pack attachment assembly, wherein the battery pack is vertically beneath a passenger compartment of an electrified vehicle.

In some aspects, the techniques described herein relate to a battery pack assembly, including: a battery pack; a first frame member on a first side of the battery pack; a second frame member on an opposite, second side of the battery pack; and a plurality of attachment assemblies each securing the battery pack to one of the first frame member or the second frame member, the plurality of attachment assemblies each including a battery pack bracket and a frame bracket that engage each other through a hook received within a pocket, the battery pack bracket removably attached to the battery pack, the frame bracket removably attached to the first frame member or the second frame member.

In some aspects, the techniques described herein relate to a battery pack assembly, wherein the pocket opens vertically upward and the hook is received within the pocket from above.

In some aspects, the techniques described herein relate to a battery pack assembly, wherein the frame bracket is provided by one of the first frame member or the second frame member.

In some aspects, the techniques described herein relate to a battery pack assembly, wherein the frame bracket is directly attached to the first frame member or the second frame member.

In some aspects, the techniques described herein relate to a battery pack assembly, wherein the battery pack bracket is removably attached to a flange of the battery pack, and the battery pack bracket can be disengaged from the flange at a position vertically beneath the flange.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a sideview of an electrified vehicle having a battery pack.

FIG. 2 illustrates the battery pack moving toward an installed position where the battery pack is secured to frame members of the electrified vehicle of FIG. 1.

FIG. 3 illustrates the battery pack in an installed position where the battery pack is secured to the frame members.

FIG. 4 illustrates a section view taken at line 4-4 in FIG. 2.

FIG. 5 illustrates a section view taken at line 5-5 in FIG. 3.

FIG. 6 illustrates a perspective view of an attachment assembly from FIG. 2.

### DETAILED DESCRIPTION

This disclosure relates generally to attaching a battery pack to an electrified vehicle, and, in particular, to attaching the battery pack in a way that facilitates service. In an example, attachment assemblies can be used to attach the battery pack to frame members of the vehicle. When attaching the battery pack, the battery pack can be moved into an installed position from above the frame members. When in the installed position, the battery pack can be removed for service from beneath the vehicle.

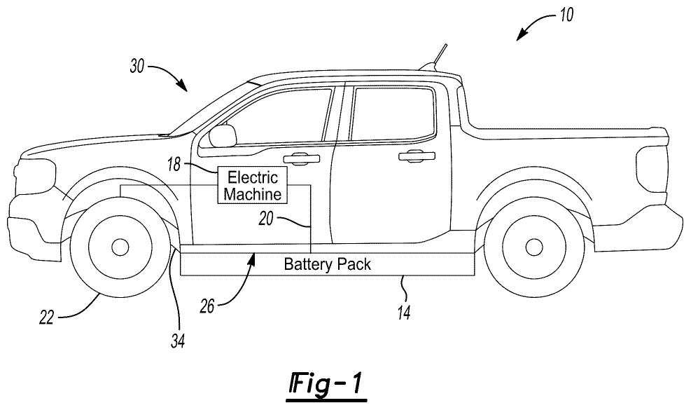

With reference to FIGS. 1-3, an electrified vehicle 10 includes a battery pack 14, an electric machine 18, and wheels 22. The battery pack 14 powers the electric machine 18, which can convert electrical power to mechanical power to drive the wheels 22. The battery pack 14 can be a relatively high-voltage, traction battery pack.

The battery pack 14 is, in the exemplary embodiment, secured adjacent to an underbody 26 of the electrified vehicle 10 beneath a passenger compartment 30. The battery pack 14 could be located elsewhere on the electrified vehicle 10 in other examples.

The electrified vehicle 10 is an all-electric vehicle. In other examples, the electrified vehicle is a hybrid-electric vehicle, which selectively drives wheels using torque provides by an internal combustion engine, instead of, or in addition to, an electric machine. Generally, the electrified vehicle 10 could be any type of vehicle having a battery pack.

Further, the example electrified vehicle 10 is a pickup truck having a unibody configuration. In another embodiment the electrified vehicle 10 could have a body-on-frame architecture, could be another type of vehicle, such as a car, van, sport utility vehicle, etc., or both.

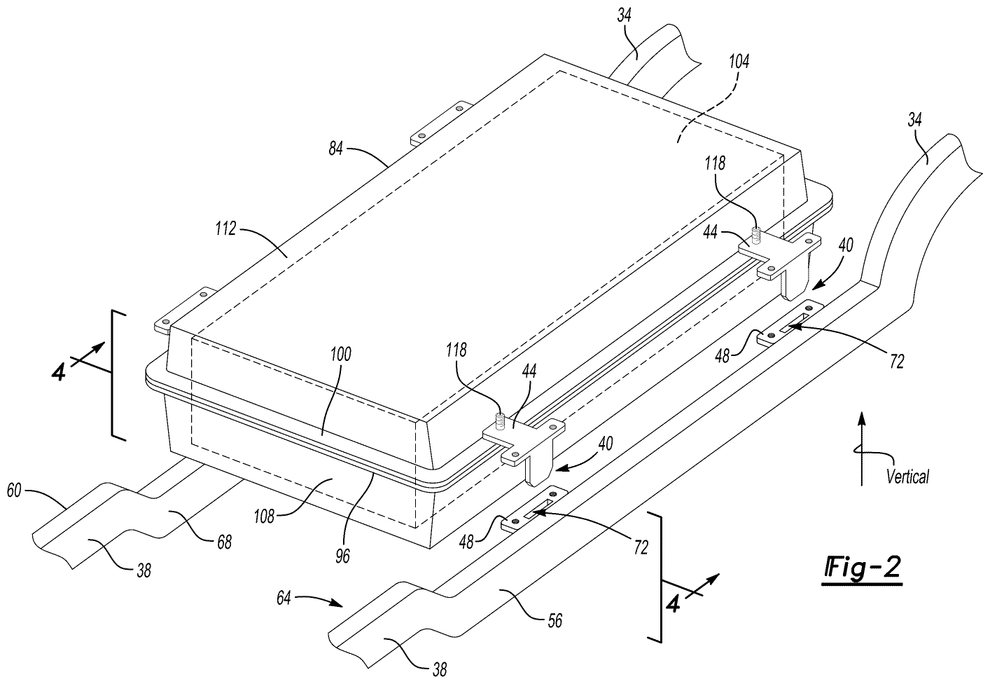

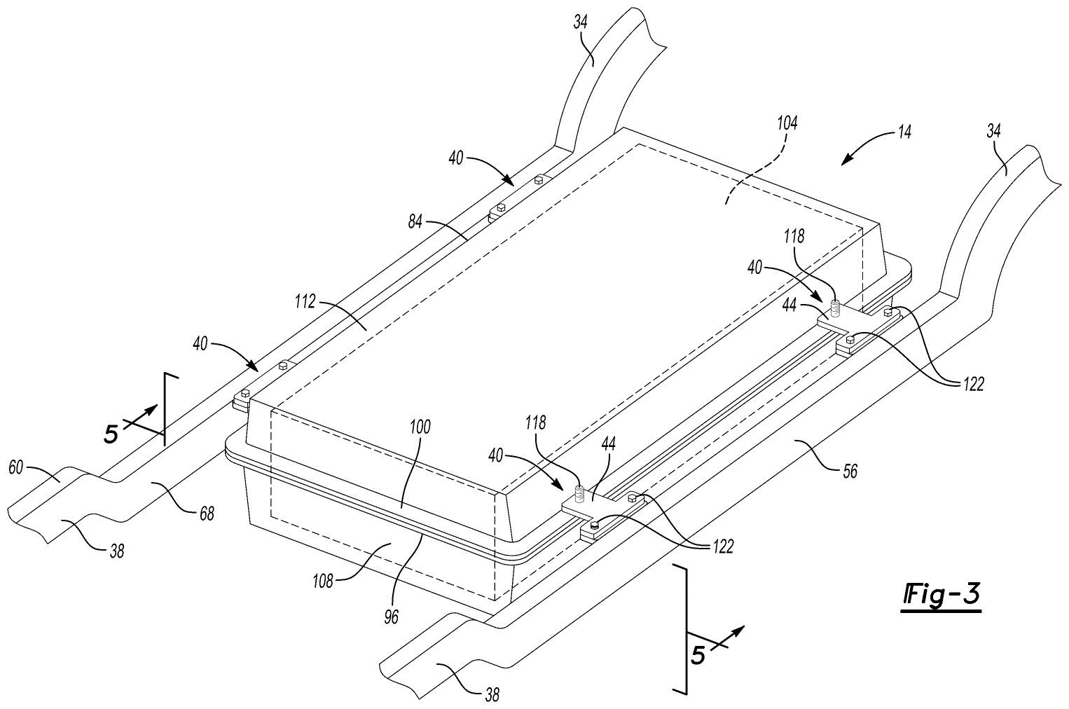

The electrified vehicle 10 includes a vehicle frame 34 or chassis. The vehicle frame 34 includes frame members 38 that extend longitudinally along a length of the electrified vehicle 10. A plurality of battery pack attachment assemblies 40 are utilized to secure the battery pack 14 to the frame members 38. During initial installation of the battery pack 14, the battery pack 14 can be moved from an uninstalled position where the battery pack 14 is vertically above the frame members 38 as shown in FIG. 2 to the installed position shown in FIG. 3.

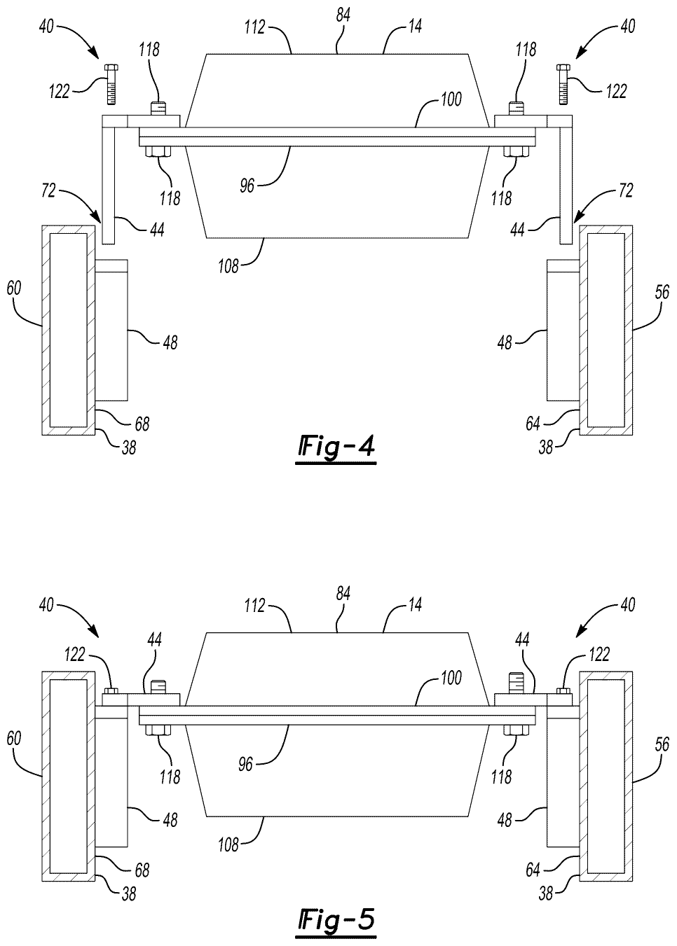

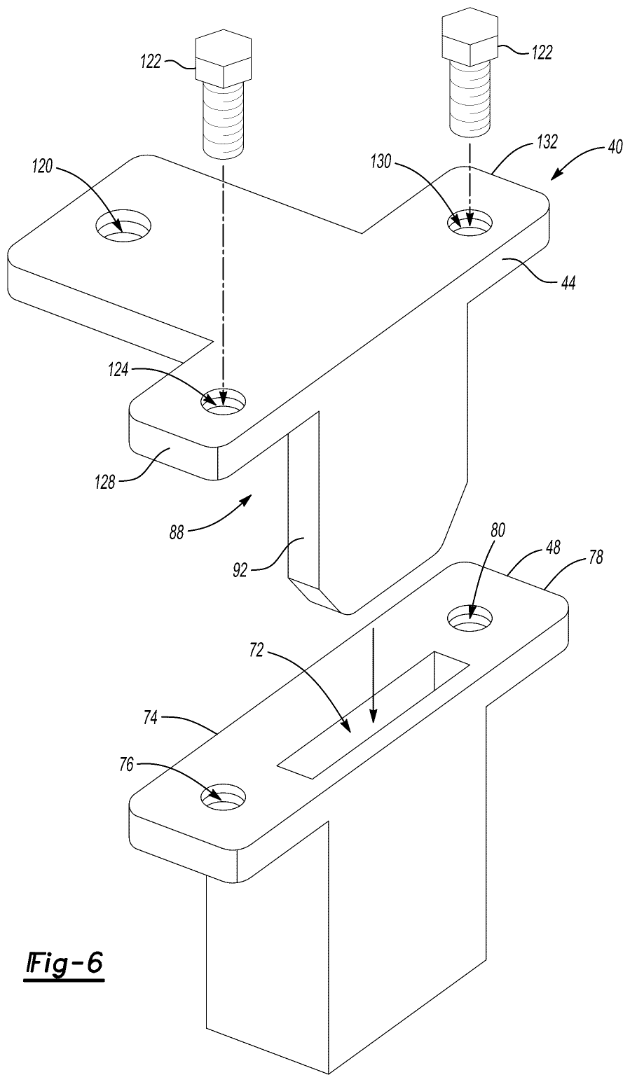

With reference now to FIGS. 4-6, the battery pack attachment assemblies 40 each include a battery pack bracket 44 and a frame bracket 48. Each of battery pack brackets 44 is removably attached to the battery pack 14. Each of the frame brackets 48 is removably attached to one of the frame members 42 of the electrified vehicle 10. The frame members 42 can be tubular frame rails that are part of a larger frame assembly.

In this example, the electrified vehicle 10 includes a driver side frame member 56 and a passenger side frame member 60. The battery pack 14 is secured adjacent to the underbody 26 between the driver side frame member 56 and the passenger side frame member 60.

In the exemplary embodiment, four of the battery pack attachment assemblies 40 are utilized to secure the battery pack 14 to the frame members 52. Two of the battery pack attachment assemblies 40 are on a driver side of the battery pack 14 and secure the battery pack 14 to the driver side frame member 56. The remaining two battery pack attachment assemblies 40 are on a passenger side of the battery pack 14 and are secured the battery pack 14 to the passenger side frame member 60.

The frame brackets 46 of the two battery pack attachment assemblies 40 on the driver side of the battery pack 14 are secured to an interior surface 64 of the driver side frame member 56. The two attachment assemblies on the passenger side of the battery pack 14 are secured to an interior surface 68 of the passenger side frame member 60. The frame brackets 48 can be secured to the interior surfaces 64 and 68 with, for example, welds, mechanical fasteners, or both.

The frame brackets 48 each include a pocket 72. In this example, the pockets 72 open vertically upward and extend downward through the respective frame brackets 48. Vertical, for purposes of this disclosure, is with reference to ground in a general orientation of the electrified vehicle 10 during operation.

The frame brackets 48 additionally each include a forward extension 74 having a first fastener bore 76 and a rear extension 78 having a second fastener bore 80. The forward extension 74 and the first fastener bore 76 are, in this example, located forward of the pocket 72. The rear extension 78 and the second fastener bore 80 are aft of the pocket 72. Forward and aft are with reference to an orientation of the electrified vehicle 10.

Securing the battery pack 14 to the frame members 42, can include fastening the battery pack brackets 44 of the exemplary battery pack attachment assemblies 40 directly to an enclosure 84 of the battery pack 14. The example battery pack brackets 44 include a hanger assembly 88 having a hook 92. In this example, the hanger assembly 88 is secured directly to a flange 96 of the enclosure 84 and, when secured, interfaces directly with an upper surface 100 of the flange 96. In this example, the hanger assembly 88 directly contacts the flange 96.

The enclosure 84, in this example, encloses one or more cell stacks 104. The example enclosure 84 includes both an enclosure tray 108 and an enclosure cover 112. In this example, the flange 96 includes both a flange of the enclosure tray 108 and a flange of the enclosure cover 112, which are joined to enclose the one or more cell stacks 104 within the enclosure 84.

To attach the battery pack brackets 44 to the flange 96, mechanical fasteners 118 extend vertically upward through the flange 96 to engage a respective threaded aperture 120 within the battery pack bracket 44. The mechanical fasteners 118 removably secure the battery pack bracket 44 to the flanged region 102. The heads of the mechanical fasteners 118 face downward and are accessible from a position beneath the flange 96.

The battery pack brackets 44 additionally each include a forward aperture 124 within a forward tab 128 that is forward the hook 92, and an aft aperture 130 within an aft tab 132 that is aft of the hook 92. Forward and aft are, for purposes of this disclosure, with reference to an orientation of the electrified vehicle 10.

During installation of the battery pack 14 to the electrified vehicle 10, the battery pack brackets 44 are mounted to the flanged region 102 of the enclosure 84, and the battery pack 14 with the battery pack brackets 44 is positioned vertically above the frame members 52 and above the pockets 72 within the frame brackets 48.

The battery pack 14 with the battery pack brackets 44 are then lowered vertically downward from the position of FIGS. 2 and 4 to the position of FIGS. 3 and 5. As the battery pack 14 and the battery pack brackets 44 are lowered, the hooks 92 of the hanger assemblies 88 received within the pockets 72 of the frame brackets 48.

Eventually, after sufficient lowering, the battery pack brackets 44 rest on the frame brackets 48 with the hooks 92 positioned within the respective pockets 72. The battery pack 14 is then supported by the frame members 52 through the frame brackets 48.

To hold the battery pack 14 in position, mechanical fasteners 122 are then, from above, inserted through the forward aperture 124 to engage the first fastener bore 76, and through the aft aperture 130 to engage the second fastener bore 80. After securing the mechanical fasteners 122, the battery pack 14 is considered in an installed position.

After the battery pack 14 is in the installed position, the remaining portions of the electrified vehicle 10 can be installed, which can include positioning the battery pack 14 beneath the underbody 26 below the passenger compartment 30.

From time to time, servicing the battery pack 14 may be necessary. To remove the battery pack 14 so that the battery pack 14 can be accessed for service, the mechanical fasteners 118 can be disengaged from the flanged region 102 of the different battery pack brackets 44 from beneath the flanged region 102. The battery pack brackets 44 can thus be detached from the battery pack 14 when the hooks 92 of the hanger assembly 88 are within the respective pocket 72.

The battery pack 14 can then move vertically downward away from the frame members 52 and the passenger compartment 30. Once removed, the battery pack 14 can be serviced and then, if required, installed back to the battery pack brackets 44 from beneath the electrified vehicle 10.

As the battery pack 14 can be removed from beneath the passenger compartment 30, removing substantial components of the electrified vehicle 10 that are vertically above the battery pack 14 is not required in order to service the battery pack 14. Initial installation of the battery pack 14 can, however, still occur from above the frame members 52. Permitting loading of the battery pack 14 initially into the installed position from above can facilitate assembly of the battery pack 14 to the electrified vehicle 10.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack attachment assembly, comprising:
a battery pack bracket of an attachment assembly that secures a battery pack to a frame member of a vehicle, the battery pack bracket removably secured to a battery pack, the battery pack bracket including a flange that is received within a pocket when the battery pack is secured to the frame member with the attachment assembly.

2. The battery pack attachment assembly of claim 1, further comprising a vehicle frame bracket that provides the pocket, the vehicle frame bracket attached to a vehicle frame.

3. The battery pack attachment assembly of claim 2, wherein the vehicle frame bracket includes one or more fastener bores each configured to receive a fastener to secure the battery pack bracket to the vehicle frame bracket.

4. The battery pack attachment assembly of claim 3, wherein the one or more fastener bores each open vertically upward.

5. The battery pack attachment assembly of claim 4, wherein the pocket opens vertically upward.

6. The battery pack attachment assembly of claim 1, wherein the pocket opens upward, and the pocket is configured to receive the flange from above.

7. The battery pack attachment assembly of claim 6, wherein the flange comprises a hooked portion that is at least partially received within the pocket.

8. The battery pack attachment assembly of claim 1, wherein the battery pack bracket is removably secured to an enclosure flange of the battery pack.

9. The battery pack attachment assembly of claim 8, wherein the battery pack bracket interfaces directly with an upper surface of the enclosure flange.

10. The battery pack attachment assembly of claim 9, further comprising at least one mechanical fastener extending vertically upward through the enclosure flange to engage the battery pack bracket to removably secure the battery pack bracket to the enclosure flange.

11. The battery pack attachment assembly of claim 10, wherein the at least one mechanical fastener is configured to be disengaged from the battery pack bracket from a position vertically beneath the enclosure flange.

12. The battery pack attachment assembly of claim 1, wherein the battery pack bracket is configured to be detached from the battery pack when the flange is received within the pocket.

13. The battery pack attachment assembly of claim 1, wherein a vehicle frame member includes the pocket.

14. The battery pack attachment assembly of claim 1, wherein the battery pack is vertically beneath a passenger compartment of an electrified vehicle.

15. A battery pack assembly, comprising:
a battery pack;
a first frame member on a first side of the battery pack;
a second frame member on an opposite, second side of the battery pack; and
a plurality of attachment assemblies each securing the battery pack to one of the first frame member or the second frame member, the plurality of attachment assemblies each including a battery pack bracket and a frame bracket that engage each other through a hook received within a pocket, the battery pack bracket removably attached to the battery pack, the frame bracket removably attached to the first frame member or the second frame member.

16. The battery pack assembly of claim 15, wherein the pocket opens vertically upward and the hook is received within the pocket from above.

17. The battery pack assembly of claim 15, wherein the frame bracket is provided by one of the first frame member or the second frame member.

18. The battery pack assembly of claim 15, wherein the frame bracket is directly attached to the first frame member or the second frame member.

19. The battery pack assembly of claim 15, wherein the battery pack bracket is removably attached to a flange of the battery pack, and the battery pack bracket can be disengaged from the flange at a position vertically beneath the flange.
